(19) United States
(12) Patent Application Publication
(10) Pub. No.: US 2017/0210210 A1
(43) Pub. Date: Jul. 27, 2017

(54) VEHICLE DOOR

(71) Applicant: GM GLOBAL TECHNOLOGY OPERATIONS LLC, Detroit, MI (US)

(72) Inventor: Marcus LANGE, Ruesselsheim (DE)

(73) Assignee: GM GLOBAL TECHNOLOGY OPERATIONS LLC, Detroit, MI (US)

(21) Appl. No.: 15/413,091

(22) Filed: Jan. 23, 2017

(30) Foreign Application Priority Data
Jan. 21, 2016 (DE) 102016000606.4

(51) Int. Cl. B60J 5/04

(52) U.S. Cl. CPC B60J 5/0411; B60J 5/0426; B60J 5/0437; B60J 5/0448; B60J 5/0402; B60J 5/0408; B60Y 2304/03; B60Y 2304/05

(57) ABSTRACT

A vehicle door includes a lower part and an upper part designed as a window frame. The upper part includes several frame elements, which are joined together by spraying plastic onto the frame elements.

### CROSS-REFERENCE TO RELATED APPLICATION

This application claims priority to German Patent Application No. 102016000606.4, filed Jan. 21, 2016, which is incorporated herein by reference in its entirety.

### TECHNICAL FIELD

The present disclosure pertains to a vehicle door with a closed lower part and an upper part designed as a window frame.

### BACKGROUND

A vehicle door must exhibit considerable stiffness when exposed to a load in both a lateral direction and in the longitudinal direction of the vehicle, so as to afford the required safety to vehicle occupants during an accident. In order to ensure this stiffness, the load-bearing parts of vehicle doors are usually made out of metal.

Known from DE 197 27 010 A1 is a vehicle door of this kind, in which an upper part configured as a window frame includes several metal parts, specifically two lateral parts, an arched frame that joins the lateral parts at the top, and a shaft reinforcement.

Assembling the upper part included of the numerous different parts is time-consuming, and the window frame is hidden behind a frame shutter toward the vehicle interior to conceal its structural design.

### SUMMARY

The present disclosure provides a vehicle door that is loadable, lightweight and efficient to assemble. In an embodiment of the present disclosure, a vehicle door with a closed lower part and an upper part designed as a window frame. The upper part includes several frame elements, which are joined together by spraying plastic onto the frame elements. Spraying makes it possible to assemble the various frame elements in a single operation with a minimal time outlay. Using plastic instead of metal helps reduce the weight. Metal can be replaced by plastic in the upper part of the door without detracting from the protective effect of the door during an accident.

The frame elements are preferably arranged sequentially around a window opening, since this enables the use of compact frame elements that are easy and economical to fabricate. Alternatively, the frame elements could also be arranged sequentially from the inside out.

To reduce the weight, the frame elements should be made out of a plastic, and preferably a fiber-reinforced plastic in order to achieve a high loading capacity for the window frame. In order to achieve a high loading capacity at a low weight, it is preferred that the fibers form a fabric.

The loading capacity can be further increased by spraying reinforcing ribs on at least one side of the fabric, in the case of a three-dimensionally formed fabric preferably on its concave side. If the fabric is formed into a groove, which in particular can extend along an edge of the window pane, the reinforcing ribs can be situated in the groove.

The at least one frame element can consist of a fiber-reinforced flat material blank, also referred to as an organic sheet or organo sheet. Alternatively, it is possible to fabricate at least one frame element by extruding a matrix plastic material together with the fabric. Both variants can be combined in a vehicle door by using respectively different techniques in fabricating their frame elements.

In order to facilitate an intimate connection between the frame elements and sprayed-on plastic, a matrix of the fiber-reinforced plastic of the frame elements preferably consists of the same material as the sprayed-on plastic.

One of the frame elements can be a shaft reinforcement. A shaft reinforcement typically includes an inner and outer branch, between which a window channel extends. The two branches can be interconnected as a single piece. However, it is also conceivable to first separately prefabricate a fiber-reinforced area of the inner and outer branch, and join the two together to yield the shaft reinforcement by spraying on plastic.

Vehicle door fabrication can include several sequential spraying steps, e.g., one in which the blanks that will each include a branch of the shaft reinforcement are first formed separately from each other and provided with reinforcing ribs, and a second or even third, in which they are joined together and with other frame elements including the window frame. However, the ribs are preferably sprayed on the frame elements and the frame elements are joined together in one and the same spraying step.

At least one of the branches of the shaft reinforcement can be configured as an angle profile with an upright leg bordering the window channel and a leg protruding from the window channel. If the shaft reinforcement exhibits a fiber-reinforced area, this angle profile is preferably involved.

The upper and lower part of the vehicle door according to the present disclosure can be joined together via adhesive bonding, in particular on adhesive flanges of the shaft reinforcement. In order to be able to join the upper door part essentially consisting of plastic with other, metal parts of the door or body in a conventional joining process used in vehicle production, at least one metal reinforcing part can be integrated into the upper part. The metal reinforcing part also makes sense given an upper part otherwise fastened through adhesive bonding. Since setting the adhesive takes time, during which the upper and lower part of the door have to be fixedly held in the desired position relative to each other, vehicle door production can be improved by having this fixation be created by a welded, in particular spot-welded, or riveted connection.

### BRIEF DESCRIPTION OF THE DRAWINGS

The present disclosure will hereinafter be described in conjunction with the following drawing figures, wherein like numerals denote like elements.

FIG. 1 is a schematic view of a vehicle door according to the present disclosure;

FIG. 2 is a three-dimensionally shaped blank of organo sheet, which is provided to form a branch of a shaft reinforcement;

FIG. 3 is the blank with sprayed-on, reinforcing ribs;

FIG. 4 are both branches of the shaft reinforcement;

FIG. 5 is a cutout of the completely formed upper part of the vehicle door; and

FIG. 6 is a cross section through another frame element of the vehicle door.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

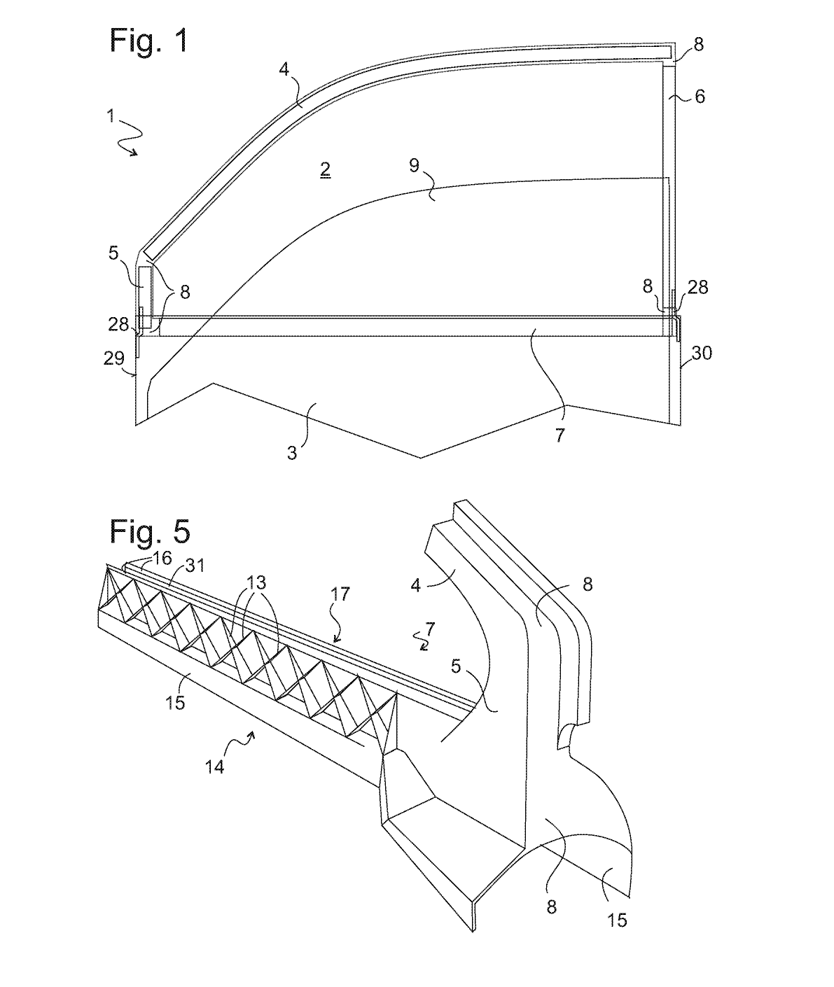

FIG. 1 is a schematic view of a vehicle door according to the present disclosure. The door includes an upper part 1 in a known manner, which includes a window frame all around a window opening 2, and a lower part 3 (a cutout of which is depicted on FIG. 1). The window frame includes an upper frame profile 4, which extends along an upper edge of the window opening 2, vertical frame profiles 5, 6 at the front and rear edge of the window opening 2, a shaft reinforcement 7 and connecting bodies 8 made out of thermoplastic materials sprayed onto the components 4-7. The connecting bodies 8 include the corners of the window frame. The shaft reinforcement 7 is concealed inside of the hollow lower part 3 in the finished vehicle door, and fastened to its outer and inner walls. It borders a shaft in a known manner, in which a window pane 9 can be adjusted between a closed position that fills out the window opening 2 and an open position that is recessed in the lower part 3.

A respective metal reinforcing part 28 can be partially embedded in those connecting bodies 8 that join a shaft reinforcement 7 with the vertical frame profiles 5, 6. A section of the reinforcing parts 28 protruding out of the connecting body 8 is provided so as to be fastened to the lower part 3 of the door, preferably to the interior side of a front or rear flank 29, 30 (as viewed in the longitudinal direction of the vehicle) of the panels forming the lower part 3 by riveting or spot welding. This fastening does not have to exhibit the loading capacity required for later use of the door in the vehicle. Rather, it is sufficient that the fastening temporarily join the upper part 1 and lower part 3 together in such a way that an adhesive layer between the two has a chance at some other point to cure, and thereby establish the desired loadable bond.

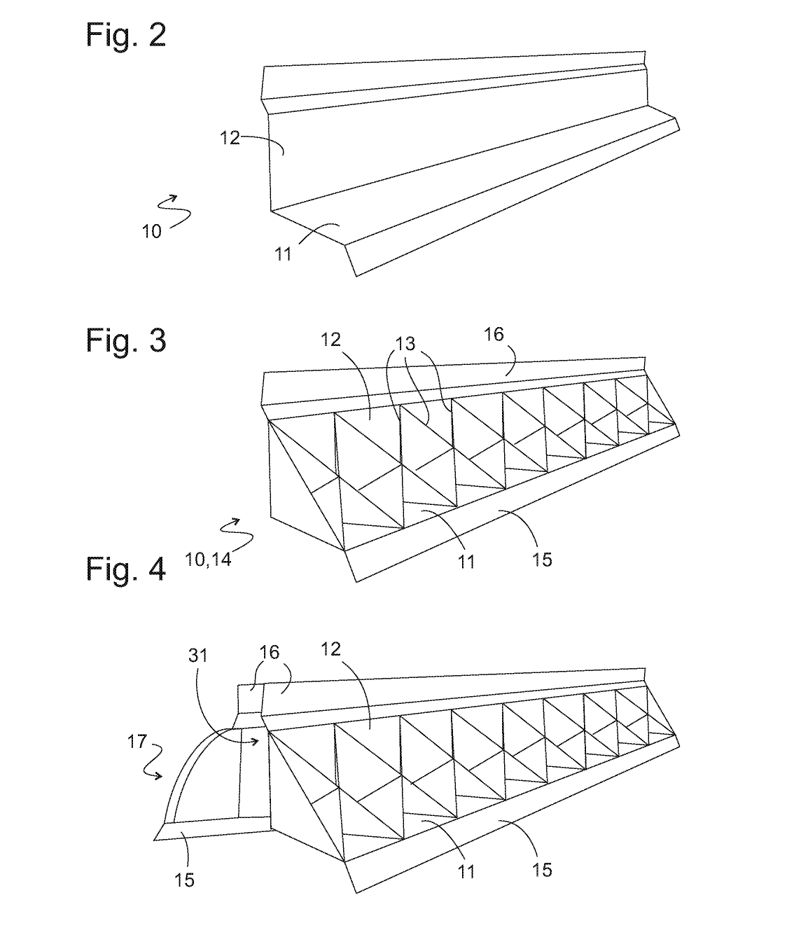

FIG. 2 shows a blank 10 made out of plastic flat material, which is provided to form an inner branch of the shaft reinforcement. The flat material includes a layer of thermoplastic material, preferably of the same plastic used to form the connecting bodies 8, and a fiber material, e.g., glass, carbon or aramid fibers. The layer of thermoplastic material can form a matrix, into which the fibers are embedded. The fibers can, however, also be adhesively bonded to a surface of the layer, e.g., by blowing pieces of fiber onto the surface coated with an adhesive. Also conceivable is to form the flat material as a laminate included of several fiber and thermoplastic layers.

In order to minimize the tendency of the flat material to expand under a tensile load as much as possible, the fibers inside of the blank 10 should be preferably oriented, e.g., in the form of crossing layers of parallel fibers, or in the form of one or more fabric layers. This type of composite flat material is available on the market under the designation organo sheet or organic sheet.

The blank 10 can also be heated and bent so as to give it the shape of an angle profile with legs 11, 12 as depicted on FIG. 2, and then further processed in the manner shown on FIG. 3 by spraying on thermoplastic material. Preferably, it is at most heated, so as to then be draped in an injection mold while in the malleable state created by heating, and given its final shape by bending while closing the injection mold and subsequently spraying on the thermoplastic material, typically by pressing one side of the blank against a wall of the injection mold, and by spraying the thermoplastic material on the opposing side of the blank.

As evident from FIG. 3, the spraying process yields numerous ribs 13 on the blank 10 between the facing sides of the two legs 11, 12. Since the ribs 13 consist of the same thermoplastic material as the matrix of the blank 10, or alternately of a higher melting plastic, the matrix of the blank 10 melts at the ends of the ribs 13 during injection, thereby giving rise to an intimate, highly loadable, material-locking bond between the legs 11, 12 and the ribs 13.

The ribs 13 join the legs 11, 12 not by the shortest path, i.e., in a plane spanned by the surface normals of both legs 11, 12, but are instead inclined relative to this plane in different directions. A higher torsional rigidity can be achieved as a result. In order to tightly stagger the ribs 13, ribs 13 inclined in respectively different directions cross each other.

The angle profile with the legs 11, 12 and the ribs 13 sprayed thereon forms a branch 14 of the shaft reinforcement 7 that lies on the inside, i.e., faces the passenger compartment door mounted in a vehicle.

Edge regions of the legs 11, 12 on which the ribs 13 do not extend form an adhesive flange 15, which is provided to be adhesively bonded to an inner wall of the lower part 3 during assembly of the door, or a beading flange 19, which is beaded around an upper edge of this inner wall.

FIG. 4 shows the inner branch 14 and an outer branch 17 of the shaft reinforcement, which are arranged on either side of a shaft 31 that guides the window pane 9 (not shown on FIG. 4). Analogously to the inner branch 14, the outer branch 17 includes a rib, which joins the legs together to form an angle profile and faces away from the viewer on FIG. 4, an adhesive flange 15 for adhesive bonding to an outer wall of the lower part 3, and a beading flange 16 for beading to the upper edge of the outer wall.

In turn, the inner branch 14 and outer branch 17 can be fabricated separately from each other and then placed together in an injection mold so as to join them to the complete shaft reinforcement by spraying connecting bodies 8 onto their ends. However, it is preferred that blanks for both branches 14, 17 be draped in a shared injection mold, and then form both the connecting bodies 8 and the ribs 13 in a single spraying process.

Accordingly, each individual frame profile 4, 5 or 6 can also optionally be separately prefabricated and placed into the injection mold, so as to spray on the connecting bodies 8 that join it with the other frame profiles or shaft reinforcement 7, or only respective blanks are first also fabricated for the frame profiles 4-6, which are draped in the injection mold so as to receive their final shape therein along with reinforcing ribs, and so as to be joined with the respective adjoining components of the window frame.

FIG. 5 shows a perspective view of a cutout of the obtained upper part 1. Shown are the front vertical frame profile 5, a portion of the upper frame profile 4, the two branches 14, 17, the shaft reinforcement 7 along with a respective connecting body 8 between the front frame profile 5 and the upper frame profile 4 or between the front frame profile 5 and the shaft reinforcement 7.

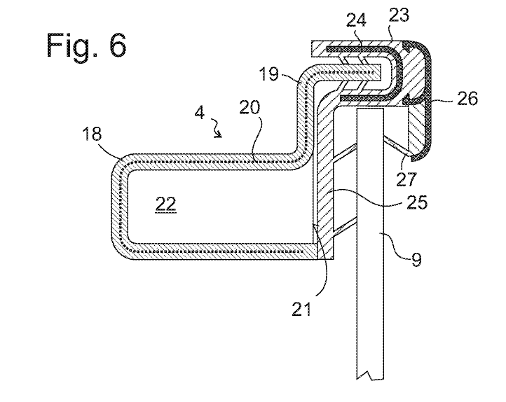

FIG. 6 shows a cross section through the upper frame profile; the front and rear frame profile 5, 6 can be assembled in the same way. The frame profile 4 includes a section 18 with a groove-shaped cross section open toward the vehicle exterior, and a section 18 with an L-shaped cross section that adjoins the upper leg of the groove-shaped section 18. A strip of fabric 20, e.g., included of glass fiber, is embedded in the frame profile 4.

The depicted cross section of the frame profile 4 can be obtained by deep drawing a blank made of organo sheet, as described above for the branches 14, 17 of the shaft reinforcement. Production can, however, also involve an extrusion technique, in particular pultrusion in which the fabric strip 20 is jacketed on both sides by a thermoplastic matrix material in an extrusion die, an endless profile with the cross section depicted on the figure and the embedded fabric 20 are pulled out of a nozzle of the extrusion die, thinned to the respectively required length, and if necessary, bent so as to be adjusted to the progression of the window frame.

The groove-shaped section 18 is reinforced by ribs, which are sprayed on its legs lying opposite each other on either side of a groove 22. Spraying can take place in the same operation where the frame profile 4 is deep drawn out of an organo sheet blank. If, by contrast, the frame profile 4 is fabricated via extrusion, it is placed in its final shape in a mold, so as to have sprayed onto it the ribs 21 and connecting bodies 8 in the same spraying process, which joins it with the other frame profiles 5, 6 and the shaft reinforcement 7 to yield the complete upper part 1. In the case of the frame profiles 5, 6, the ribs 21 could each be missing on a lower end of the groove 22, so that the metal reinforcing part 28 could there be inserted, or the ribs 12 could be sprayed on after inserting the reinforcing part 28, thereby securing it in the groove 22.

A sealing profile 23 is plugged onto a free end of the L-profile section 19. The sealing profile 23 is an extruded profile included of an easily deformable material, typically a rubber. In order to ensure a fixed seating on the L-profile section 19 despite the easy deformability, an elastic metal profile 24 with a U-shaped cross section is embedded in the sealing profile 23, and keeps the sealing profile 23 pressed against the L-profile section 20 from both sides. A leg 25 of the sealing profile 23 covers the groove 22, and itself forms a side wall of a downwardly open groove, which accommodates the upper edge of the window pane 9 in its closed position. A second side wall of this groove is included of a profile 26 that is latched onto an exterior side of the sealing profile 23 and consists of a material more difficult to deform than the rubber of the sealing profile 23, e.g., a thin-walled metal or a rigidly elastic plastic, and a sealing lip 27 fastened to the interior side of the profile 26 and facing the window pane 9.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

1-15. (canceled)

16. A vehicle door comprising a lower door part and an upper window frame part, wherein the upper window frame part includes a plurality of frame members joined by sprayed plastic joints.

17. The vehicle door according to claim 16, wherein the frame members are arranged sequentially around a window opening.

18. The vehicle door according to claim 16, wherein at least one frame member comprises a fiber-reinforced plastic frame member.

19. The vehicle door according to claim 16, wherein the at least one frame member comprises a plastic frame member having fiber fabric reinforcement.

20. The vehicle door according to claim 19, further comprising spray-formed reinforcing ribs onto at least one side of the fiber fabric reinforcement.

21. The vehicle door according to claim 20, wherein the fiber fabric reinforcement is formed into a groove, and the ribs are situated in the groove.

22. The vehicle door according to claim 18, wherein the fiber-reinforced plastic frame member comprises a fiber-reinforced flat material blank.

23. The vehicle door according to claim 18, wherein the fiber-reinforced plastic frame member comprises an extruded matrix plastic material including the fiber fabric reinforcement.

24. The vehicle door according to claim 18, wherein a matrix of the frame members includes the same material as the sprayed-on plastic.

25. The vehicle door according to claim 16, wherein one of the frame members comprises a shaft reinforcement.

26. The vehicle door according to claim 25, wherein the shaft reinforcement comprises an inner branch and an outer branch between which a window channel extends.

27. The vehicle door according to claim 26, wherein at least one of the inner and outer branches is designed as an angle profile with an upright leg bordering the window channel and a leg protruding from the window channel.

28. The vehicle door according to claim 16, wherein the upper part and lower part are joined via adhesive bonding.

29. The vehicle door according to claim 16, further comprising at least one metal reinforcing part integrated into the upper part with a sprayed-on plastic.

30. The vehicle door according to claim 29, wherein the metal reinforcing part is joined with the lower part with one of a weldment or a rivet.
